(19) United States
(12) Patent Application Publication
(10) Pub. No.: US 2025/0387653 A1
(43) Pub. Date: Dec. 25, 2025

(54) TERMINAL BLOCK WITH SELF-CONTAINED FIRE-EXTINGUISHING DEVICE AND HEAT-CHEMICAL TRIGGERING

(71) Applicant: Yuriy Alexandrovich Gabliya, Moscow (RU)

(72) Inventor: Evgenii Sergeevich KAPLUN, Malaya Tsarevshchina (RU)

(21) Appl. No.: 18/877,143

(22) PCT Filed: May 30, 2024
(86) PCT No.: PCT/RU2024/000174

§ 371 Date: Dec. 19, 2024

(30) Foreign Application Priority Data
Sep. 14, 2023 (RU) 2023123788

(51) Int. Cl. A62C 31/12; A62C 3/16

(52) U.S. Cl. CPC A62C 31/12; A62C 3/16

(57) ABSTRACT

The invention relates to autonomous fire-extinguishing plants based on aerosol-forming or gas-forming compositions. It can be used to prevent fire in switchboards, sub-outlets, computers, electronic equipment (REA), elements of digital and analog modules, electronic boards. The terminal block with an autonomous fire-extinguishing device and heat-chemical triggering is made in a dielectric housing (1) and comprises metal contacts (3) with wire attachment points. The metal contacts (3) with the attachment points are a contact group forming a closed electrical circuit. A module (2) with an aerosol-forming or gas-forming composition is located inside the dielectric housing. The thermal fuse (4) is connected to a closed electrical circuit between the metal contacts (3) with the attachment points of the contact group and is designed with the possibility of breaking the closed electrical circuit by exceeding the load current flowing through it or exceeding the maximum average volume temperature. The heat-chemical igniter is connected to the module (2). The heat-sensitive element (8) is connected to a heat-chemical igniter. The dielectric housing comprises an open part, which is also a nozzle opening for the exit of extinguishing products. It provides the possibility of using a terminal block with a built-in autonomous fire-extinguishing device for connecting wires, the possibility of initializing an autonomous fire-extinguishing device with a heat-chemical igniter and breaking an electrical circuit in the form of wires connected to the terminal block.

### FIELD OF INVENTION

The invention relates to autonomous fire extinguishing plants based on aerosol-forming or gas-forming compositions and can be used to prevent fire in the switchboards, outlet extensions and sub-outlets, computers, radio electronic equipment (REA), elements of digital and analog modules, electronic boards.

When operating the electrical equipment, fire often occurs which causes are as follows: overload of electrical equipment and wiring at the junction points, short circuit, ignition of flammable materials near connected equipment, excessive transient resistance in the contact groups of electrical wiring or printed circuit boards.

It is necessary to duly and automatically suppress the fire at the incipient stage with the possibility of voltage removal from the protected device (protected devices), and the formation of an information signal about the operation of the fire-extinguishing device automatically, without human intervention, eliminating the possibility of electric shock and saving expensive equipment, protecting the elements of automation and REA.

### STATE OF ART

The fire-extinguishing means that are known from the background of invention and designed to suppress fire in electrical installations are presented below.

An autonomous fire-extinguishing plant based on a thermally activated agent contained in microcapsules (patent RU 179466), comprising a polymer composite plate having a regular surface relief and containing microcapsules with a fire-extinguishing agent placed in a special organosilicon compound. The substrate of the plate on the reverse side has a heat-resistant self-adhesive layer for its fastening in the protected volume. Microcapsules of 50-400 microns are used as a fire-extinguishing agent, having a core of a fire-extinguishing ozone-safe liquid placed inside a spherical polymer shell (patent RU 2469761). Microcapsules are capable of explosive destruction when the temperature reaches 90° C. This fire-extinguishing system is characterized by a low extinguishing capacity and a short service life (as the application practice shows, it is no more than two years) which is a significant disadvantage.

An autonomous gas fire-extinguishing plant (patent RU 139678) which comprises a cylinder with a gas-extinguishing agent (for example, halon), communicating with a main for supplying a fire-extinguishing medium to a protected volume designed using a fusible polymer material. The main is connected to the cylinder by means of a shut-off and starting device with a pressure gauge and a ball valve, and is also equipped with an elastic outer shell in the form of a metal spiral. This fire-extinguishing plant is characterized by multicomponence and high complexity of installation in a protected volume.

A mean of fastening a fire-extinguishing wire in an electric cabinet is known (patent RU 190409). A fire-extinguishing wire or pyrowire is an autonomous fire-extinguishing plant with a thermally activated microcapsulated fire-extinguishing agent designed to provide protection against fires in large-sized fire-hazardous facilities with electrical equipment such as switchboards, control cabinets, electrical cabinets, safes, etc. The technique according to this patent is a device holding a fire-extinguishing wire in an electric cabinet, having a support for fastening to the inner walls of the electric cabinet and designed in the form of a bending mount having a slot for holding the wire, and the base of the mount has an adhesive layer. The disadvantage of this technique is the complexity of a fire-extinguishing wire installation, associated with the need to install the claimed mean of fastening to the inner walls of the electrical cabinet along its perimeter, after which the fire-extinguishing wire is fastened in the mount.

A self-working fire-extinguishing device is known (patent RU 184841) which contains a foam housing comprising an explosive device and a fire-extinguishing agent. The explosive device is connected to a fire-conducting wire extending outward through the housing hole, and laid in a closed recess designed from the outside of the housing along its perimeter, and the width of the recess exceeds the width of the fire-conducting wire. To facilitate the rupture of the housing when an explosive device is triggered, grooves are designed on the inside of the housing. This device is suspended from a bracket or placed on a flat surface and independently activates when the flame contacts the fire-conducting wire. The disadvantage of this technique is that the fire-extinguishing device is placed in a guarded room with electrical equipment using a bracket or installed on a flat surface limiting its location options and reduces the effectiveness of fire extinguishing.

An automatic fire-extinguishing device for telecommunication equipment is known which is placed in a standard closed-type telecommunications rack (TCR) (patent RU 190222). The device is a single structure containing a housing comprising a flame-extinguishing agent generator (FEAG); the flame-extinguishing agent generator consists of two containers that are connected to a flame-extinguishing agent delivery system to the ignition source, consisting of pipelines and FEAG nozzles. The device triggering unit is designed in the form of an external linearly extended sensor, which is routed through the most heat-loaded areas of the TCR and connected to the input of the device, which, in turn, is connected inside the device to a sensor exceeding the temperature threshold. Additionally, this device comprises an alarm device (a light and sound indicator) indicating the fact that the generator has produced a flame-extinguishing agent. In this automatic fire-extinguishing device, standard flame-extinguishing agents are offered for use; they are characterized by insufficient extinguishing capacity and are unsafe in their chemical composition. It reduces the effectiveness of extinguishing, and the presence of pipelines and nozzles for supplying a flame-extinguishing agent to a guarded room increases the complexity of manufacturing the device, as well as installing the device in other types of rooms with electrical equipment is characterized by increased complexity of manufacturing in due to the use of standard methods of fastening to the TCR.

An autonomous fire-extinguishing device with a fastening on a DIN rail is known (patent RU 204767), comprising a housing that has a fire-extinguishing aerosol generator (FAG) with a triggering unit is located; FAG is constructed in the form of a housing designed using a non-flammable material with an outlet nozzle into which an aerosol-forming or gas-forming composition (AFC) is placed, and the housing of automatic firefighting system comprises nozzle openings for the output of an aerosol-forming or gas-forming composition and a slot for attaching the housing from FAG to a DIN rail, and the triggering unit comprises the form of a self-igniting thermal wire. Preferably, the triggering unit comprises the form of a self-igniting thermal wire with a heat-sensitive element; the activation temperature is less than the activation temperature of the thermal wire. The disadvantage of this device is that only a heat-sensitive wire and an element with high operating temperatures are used, namely, it is known that such heat-sensitive elements operate at a temperature of at least 150° C.-180° C. not allowing a rapid response to an increase in temperature during a fire and greatly delaying the start of the extinguishing cycle. The absence of an eclectic igniter does not allow the device to be triggered by an external signal. In addition, there are no thermal fuses in the device not allowing to disconnect the load from the supply voltage in the event of a fire in the protected device. It should be noted that the device claimed in the patent does not comprise a triggering sensor and is not capable of issuing a signal at the beginning of the extinguishing process. Also, the device claimed in the patent is designed to be mounted only on a DIN rail and based on its size, it cannot be mounted in small volumes, for example, sub-outlets, power supplies, REA elements or computers.

A patent is known (GB 643188, 15.09.1950) which describes improvements related to explosion-extinguishing and fire prevention or extinguishing, in which equipment for detecting and suppressing fire or explosion comprises pressure-sensitive membrane means for detecting pressure increases and if a fire or explosion occurs, the diaphragm is selected with a high level of sensitivity, for example, to react to a slight increase in pressure when the rate of pressure increase exceeds 50 psi per second and is capable of closing an electrical contact within 0.02 seconds after the pressure increase begins to release a substance suppressing a fire or explosion. Materials for suppressing or extinguishing an explosion or combustion may comprise methyl bromide or other substances, i.a. rock dust. The invention can also be applied to processes such as cotton spinning and milling. This technical solution can be chosen as the closest analogue to the claimed invention and can act as a prototype.

### DISCLOSURE OF INVENTION

The technical problem that the claimed solution is aimed at solving the functionality expansion of the terminal block.

The technical result of the claimed invention consists in providing the possibility of using a terminal block with a built-in autonomous fire-extinguishing device for connecting wires, providing the possibility of initializing an autonomous fire-extinguishing device with a heat-chemical igniter and breaking an electrical circuit in the form of wires connected to the terminal block.

The achievement of this technical result is carried out due to the housing of the terminal block, made with the possibility of placing contact groups in it, a module with an aerosol-forming or gas-forming composition, an triggering unit in the form of a heat-chemical igniter comprising a heat-sensitive element; in addition, there is a heat-sensitive fuse connected to contact groups in the housing, capable of breaking an electrical circuit by exceeding the flowing current through it, the load current or excess temperature created by a burning aerosol-forming or gas-forming composition.

Alternatively, the terminal block housing comprises fasteners capable of connecting several terminal block housings to each other in a group.

Preferably, the triggering unit is made in the form of a heat-chemical igniter with a heat-sensitive chemical element, the triggering temperature of which is less than the triggering temperature of the heat-chemical igniter of the AFC.

The claimed device is an assembly unit made in a single housing, and has a functional and constructive unity, therefore it can be claimed as a patent.

The possibility of mounting the claimed device comprising the AFC with a solid-fuel aerosol-forming or gas-forming composition, and a heat-sensitive fuse inside the limited volumes with electrical or electronic equipment allows suppressing fire in installation sites with high extinguishing efficiency and disconnecting the load that is the source of ignition.

Taking into account that the aerosol-forming composition, in comparison with powder, carbon dioxide and foam compositions, has no restrictions on use (in terms of the power of the protected electrical equipment and the presence of voltage) and does not adversely affect electrical equipment or electronic equipment, the claimed device can be installed anywhere in the protected devices.

The presence of a triggering unit, in the form of a heat-chemical AFC igniter, which is triggered using a triggering heat-sensitive device, makes it possible to trigger the device at relatively lower operating temperatures, for example, 1730 C, which gives greater versatility and allows the use of a terminal block as an element that expands the extinguishing capabilities of electrical devices.

The use of the terminal block housing of the smallest size makes it possible to install the terminal block without special mounting in any types of sub-outlets, switchboards, power supplies, REA housings, digital or electronic modules, on printed circuit boards and reduces the complexity in the manufacture of the device.

The aerosol-forming or gas-forming composition is a low-temperature solid fuel composition.

### EMBODIMENT OF INVENTION

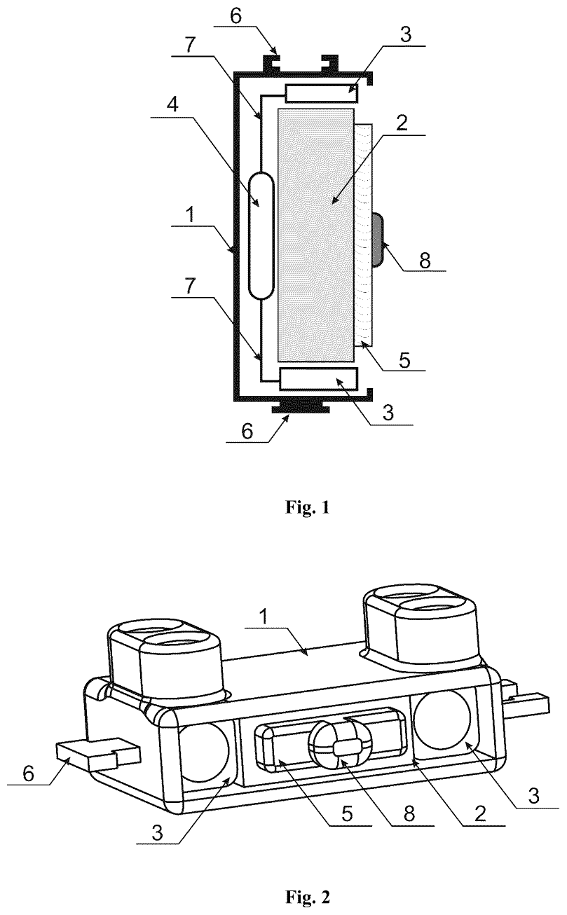

FIG. 1 shows a diagram of the claimed terminal block, where 1 is a housing, 2 is a module with an aerosol-forming or gas-forming composition, 3 is a contact block, 4 is a thermal fuse with conductors (7), 5 is a heat-chemical igniter with a heat-sensitive element (8), 6 is a housing mount, 7 are conductors, 8 is a heat-sensitive element.

The terminal block comprises an aerosol-forming or gas-forming composition (2) and a compact dielectric housing (1). The module (2) is placed in the housing (1) through the opened side of the housing, which is also a nozzle opening. Also, a thermal fuse (4) is placed in the housing (1) before placing the module with an aerosol-forming or gas-forming composition (2), connected by its conductors (7) to the contact blocks (3) in a closed electrical circuit.

The terminal block can be placed in the housing of any electrical device, being connected to the load through contact blocks (3), conductors (7) and a thermal fuse (4).

The AFC triggering unit is a heat-chemical igniter (5) with a heat-sensitive element (8).

Preferably, the heat-chemical igniter (5) is made in the form of a housing element and is equipped with a heat-sensitive element (8) located, for example, at the end of the heat-chemical igniter (5), which reduces the temperature of spontaneous combustion, for example, to 173° C. and below. The triggering temperature of the heat-sensitive element (8) is less than the triggering temperature of the heat-chemical igniter (5).

Preferably, fasteners (6) are located on the outer part of the housing (1), allowing the terminal blocks to be connected to each other in groups to connect two or more pairs of wires.

Preferably, the contact groups (3) are made in the form of screw contacts, where the input wire is fixed with a screw or screw and a clamping pad.

Alternatively, the contact groups (3) are made in the form of non-removable crimping sleeves, where the input wire is fixed in the form of compression by the contact group (3).

Alternatively, the contact groups (3) are made in the form of a spring contact capable of independently pressing the input wire to the contact group (3) when inserting the wire into the contact group (3).

Alternatively, the contact groups (3) are made in the form of a movable clamp contact, which can be opened with a lever clamp, and then clamped by returning the lever clamp to its original position, thereby clamping the input wire in the contact group (3).

Initially, the load wires are connected to the contact group (3) of the terminal block. Further, the contact group (3) is connected through conductors (7) and a thermal fuse (4) into a closed circuit in which, for example, a voltage of 220 V is applied and in which current flows, for example, up to 16 amperes. The thermal fuse is selected, for example, for the nominal operating voltage of 230 V and the maximum load current of 16 amperes, as well as the opening temperature of 90° C. In case of a sharp increase in the load current in the terminal block above, for example, 16 amperes (short circuit), the thermal fuse (4) burns out and opens the line: contact group (3)—conductor (7)—thermal fuse (4)—conductor (7)—contact group (3). In this case, the contact block acts simultaneously as a safety element of the electrical circuit and a connecting element of two wires.

In the event of a fire in the protected volume (installation sites of the terminal block), when the maximum average volume temperature is reached, for example, 173° C., a heat-sensitive element (8) is triggered at the heating temperature, igniting a heat-chemical igniter (5), which in turn ignites an aerosol-forming or gas-forming composition (2). During combustion, an aerosol-forming or gas-forming composition (2) releases a fire-extinguishing aerosol that suppresses fire as quickly as possible in the protected volume. A fire-extinguishing aerosol is a well-known fire-extinguishing agent (FEA), which is a product of the combustion reaction of the initial pyrotechnic components. For example, the FEA may be potassium chloride (KCI) or sodium chloride (NaCl). The released solid particles have a size of 1-5 microns, which makes it possible to create a large FEA surface area. The particles of the extinguishing aerosol participate in the ion exchange process when suppressing the combustion reaction, which is the main effect in extinguishing fire.

When combusting, the aerosol-forming or gas-forming composition (2) also acts with the heat released on the thermal fuse (4) heating it above the operating temperature, for example, 90° C. allowing to open the power line: contact group (3)—conductor (7)—thermal fuse (4)—conductor (7)—contact group (3). Thus, if a fire occurs in the protected volume, the terminal block is able not only to extinguish the fire, but also to turn off the load at the same time, thereby eliminating the source of the fire itself.

In the event of a fire between the wires in the contact block itself, when the maximum heating temperature of the contact block elements, for example, 173° C., is reached, a heat-sensitive element (8) is triggered by the heating temperature, igniting a heat-chemical igniter (5), which in turn ignites an aerosol-forming or gas-forming composition (2). Similarly, the triggering of a module with an aerosol-forming or gas-forming composition (2) can occur independently, for example, at temperatures above 220° C. It should be noted that the terminal block housing is made of hard-to-burn materials with a melting or gorenje temperature above 250° C. During combustion, an aerosol-forming or gas-forming composition (2) releases a fire-extinguishing aerosol that suppresses fire as quickly as possible in the protected volume. A fire-extinguishing aerosol is a well-known fire-extinguishing agent (FEA), which is a product of the combustion reaction of the initial pyrotechnic components.

When combusting, the aerosol-forming or gas-forming composition (2) also acts with the heat released on the thermal fuse (4) heating it above the operating temperature, for example, 90° C. allowing to open the power line: contact group (3)—conductor (7)—thermal fuse (4)—conductor (7)—contact group (3). Thus, if a fire occurs in the contact group (3), the terminal block is able not only to extinguish the fire of its own contact group (3), but also to turn off the load at the same time, thereby eliminating the source of the fire itself.

The tests carried out showed that the mass of the aerosol-forming or gas-forming composition (2) in the amount of 0.7 grams is sufficient to stably suppress fire in a volume of up to 10 liters while acting with the combustion products of the aerosol-forming or gas-forming composition (2) on the thermal fuse (4) and turn it off.

A series of tests showed the complete autonomy of the device and stable operation in a wide range of operating temperatures.

1. The terminal block with an autonomous fire-extinguishing device and heat-chemical triggering, made in a dielectric housing (1) and comprising metal contacts (3) with wire attachment points, metal contacts (3) with attachment points are a contact group forming a closed electrical circuit,
additionally, comprise a module (2) with an aerosol-forming or gas-forming composition located inside a dielectric housing, and a thermal fuse (4) connected to a closed electrical circuit between metal contacts (3) with contact group attachment points, made with the possibility of breaking a closed electrical network by exceeding the load current flowing through it or exceeding the maximum average volume temperature,
as well as a heat-chemical igniter (5) connected to the module (2),
a heat-sensitive element (8) connected to a heat-chemical igniter, while the dielectric housing comprises an open part, which at the same time is a nozzle opening for the exit of extinguishing products.

2. The block according to claim 1, characterized by lower triggering temperature of the heat-sensitive element (8) in comparison with the triggering temperature of the heat-chemical igniter (5).

3. The block according to claim 1, characterized by fasteners (6) which are located on the outer part of the housing (1), allowing the terminal blocks to be connected to each other in groups to connect two or more pairs of wires.

4. The block according to claim 1, characterized by the contact groups (3) which are made in the form of screw contacts, where the input wire is fixed with a screw or screw and a clamping pad.

5. The block according to claim 1, characterized by the contact groups (3) which are made in the form of non-removable crimping sleeves, where the input wire is fixed in the form of compression by the contact group (3).

6. The block according to claim 1, characterized by the contact groups (3) which are made in the form of a spring contact capable of independently pressing the input wire to the contact group (3) when inserting the wire into the contact group (3).

7. The block according to claim 1, characterized by the contact groups (3) which are made in the form of a movable contact clamp, which can be opened with a lever clamp, and then clamped by returning the lever clamp to its original position. thereby clamping the input wire in the contact group (3).
